(19) United States
(12) Patent Application Publication
(10) Pub. No.: US 2026/0164086 A1
(43) Pub. Date: Jun. 11, 2026

(54) ELECTRONIC APPARATUS AND CONTROLLING METHOD THEREOF

(71) Applicant: Samsung Electronics Co., Ltd., Suwon-si (KR)

(72) Inventors: Jeongrok JANG, Suwon-si (KR); Junghee KIM, Suwon-si (KR); Jinsol PARK, Suwon-si (KR); Minkyo SEO, Suwon-si (KR); Suho CHO, Suwon-si (KR)

(73) Assignee: Samsung Electronics Co., Ltd., Suwon-si (KR)

(21) Appl. No.: 19/395,212

(22) Filed: Nov. 20, 2025

Related U.S. Application Data
(63) Continuation of application No. PCT/KR2025/014975, filed on Sep. 24, 2025.

(30) Foreign Application Priority Data
Dec. 9, 2024 (KR) 10-2024-0181783

(51) Int. Cl. H04N 21/44; G06V 10/70; G06V 10/74; G06V 10/764; G06V 20/40; H04N 21/45; H04N 21/482

(52) U.S. Cl. CPC H04N 21/44008; G06V 10/761; G06V 10/764; G06V 10/768; G06V 20/41; H04N 21/4532; H04N 21/4826

(57) ABSTRACT

An electronic apparatus includes a memory storing instructions, and at least one processor including processing circuitry, and the instructions, when executed individually or collectively by the at least one processor, cause the electronic apparatus to obtain content data that includes image data and audio data, obtain, based on a user input corresponding to performing a chapter function that is associated with classifying a plurality of image frames included in the image data for each pre-set theme being received, a profile and a prompt corresponding to a user, and provide a chapter list that includes a target chapter associated with the pre-set theme and a target frame corresponding the target chapter based on the content data, the profile, and the prompt.

### CROSS-REFERENCE TO RELATED APPLICATION

This application is a bypass continuation of International Application No. PCT/KR 2025/014975, filed on Sep. 24, 2025, which is based on and claims priority to Korean Patent Application No. 10-2024-0181783, filed on Dec. 9, 2024, in the Korean Intellectual Property Office, the disclosures of which are incorporated by reference herein in their entireties.

### BACKGROUND

### 1. Field

The disclosure relates to an electronic apparatus and a controlling method thereof, and more particularly to an electronic apparatus that categorizes a plurality of frames included in content and a controlling method thereof.

### 2. Description of Related Art

A content may include a plurality of image frames and audio data output together with the plurality of image frames. The plurality of image frames may include various scenes.

A user may recognize an overall gist of a content through summary information. A function for summarizing content or categorizing content may be necessary for the user to selectively view only a portion indicating a specific theme.

A chapter function may be a function that summarizes or categorizes content according to a specific theme. An electronic apparatus may provide the chapter function to the user. If both a detailed operation and an algorithm associated with the chapter function are the same, a specific result may not be provided to the user.

For example, in order to selectively view only a content portion of a specific team desired by the user in a sports game, an operation for selecting a theme may be necessary separately.

In addition to a situation (a team supported by the user, a team not supported by the user) with a simple selection such as sports, there may be a complicated situation. Preference for various context may vary by user.

### SUMMARY

The disclosure has been designed to improve the above-described problem, and an object of the disclosure is in providing an electronic apparatus that performs a chapter function by reflecting a preference of a user and a controlling method thereof.

According to an embodiment, an electronic apparatus includes a memory storing instructions, and at least one processor including processing circuitry, and the instructions, when executed individually or collectively by the at least one processor, cause the electronic apparatus to obtain content data that includes image data and audio data, obtain, based on a user input for performing a chapter function that is associated with classifying a plurality of image frames included in the image data for a pre-set theme being received, a profile and a prompt corresponding to a user, and provide a chapter list that includes a target chapter associated with the pre-set theme and a target frame corresponding the target chapter based on the content data, the profile, and the prompt.

The profile may include weight value information corresponding to priority with respect to context, and the prompt may include a condition corresponding to generating the chapter list.

The instructions, when executed individually or collectively by the at least one processor, cause the electronic apparatus to obtain a scene context included in the plurality of image frames based on a scene object included in the plurality of image frames, and identify the target chapter based on the profile, the prompt, the scene object, and the scene context.

The instructions, when executed individually or collectively by the at least one processor, cause the electronic apparatus to obtain script information corresponding to a content gist based on the content data, and obtain at least one from among the scene object or the scene context based on the script information.

The instructions, when executed individually or collectively by the at least one processor, cause the electronic apparatus to identify the target frame corresponding to the target chapter from among the plurality of image frames based on the scene object and the scene context.

The instructions, when executed individually or collectively by the at least one processor, cause the electronic apparatus to obtain a representative object and a representative context corresponding to a target chapter, obtain a first similarity of the representative object and the scene object, obtain a second similarity of the representative context and the scene context, and identify the target frame corresponding to the target chapter from among the plurality of image frames based on at least one from among the first similarity or the second similarity.

The instructions, when executed individually or collectively by the at least one processor, cause the electronic apparatus to identify, based on the first similarity being greater than or equal to a first threshold value, an image frame including a scene object corresponding to the first similarity as the target frame, and identify, based on the second similarity being greater than or equal to a second threshold value, an image frame including a scene context corresponding to the second similarity as the target frame.

The instructions, when executed individually or collectively by the at least one processor, cause the electronic apparatus to update the profile based on at least one from among a content viewing history, a content search history, or a chapter use history.

The user input may be a first user input, and the instructions, when executed individually or collectively by the at least one processor, cause the electronic apparatus to update, based on a second user input corresponding to selecting the chapter list being received, the profile based on the chapter use history obtained based on the second user input.

The instructions, when executed individually or collectively by the at least one processor, cause the electronic apparatus to obtain the chapter list through an artificial intelligence model corresponding to a content analysis based on the content data, the profile, and the prompt.

According to an embodiment, a controlling method of an electronic apparatus includes obtaining content data that includes image data and audio data, obtaining, based on a user input for performing a chapter function that is associated with classifying a plurality of image frames included in the image data for a pre-set theme being received, a profile and a prompt corresponding to a user, and providing a chapter list that includes a target chapter associated with the pre-set theme and a target frame corresponding the target chapter based on the content data, the profile, and the prompt.

The profile may include weight value information corresponding to priority with respect to context, and the prompt may include a condition corresponding to generating the chapter list.

The controlling method may include obtaining a scene context included in the plurality of image frames based on a scene object included in the plurality of image frames, and identifying the target chapter based on the profile, the prompt, the scene object, and the scene context.

The controlling method may include obtaining script information corresponding to a content gist based on the content data, and obtaining at least one from among the scene object or the scene context based on the script information.

The controlling method may include identifying the target frame corresponding to the target chapter from among the plurality of image frames based on the scene object and the scene context.

The identifying the target frame may include obtaining a representative object and a representative context corresponding to a target chapter, obtaining a first similarity of the representative object and the scene object, obtaining a second similarity of the representative context and the scene context, and identifying the target frame corresponding to the target chapter from among the plurality of image frames based on at least one from among the first similarity or the second similarity.

The identifying the target frame may include identifying, based on the first similarity being greater than or equal to a first threshold value, an image frame including a scene object corresponding to the first similarity as the target frame, and identifying, based on the second similarity being greater than or equal to a second threshold value, an image frame including a scene context corresponding to the second similarity as the target frame.

The controlling method may include updating the profile based on at least one from among a content viewing history, a content search history, or a chapter use history.

The user input may be a first user input, and the controlling method may include updating, based on a second user input corresponding to selecting the chapter list being received, the profile based on the chapter use history obtained based on the second user input.

The controlling method may include obtaining the chapter list through an artificial intelligence model corresponding to a content analysis based on the content data, the profile, and the prompt.

### BRIEF DESCRIPTION OF THE DRAWINGS

FIG. 1 is a diagram illustrating a content chapter function according to an embodiment;

FIG. 2 is a block diagram illustrating an electronic apparatus according to an embodiment;

FIG. 3 is a block diagram illustrating a detailed configuration of the electronic apparatus in FIG. 2 according to an embodiment;

FIG. 4 is a diagram illustrating an operation for generating a chapter list according to an embodiment;

FIG. 5 is a diagram illustrating an operation for processing a non-real-time content according to an embodiment;

FIG. 6 is a diagram illustrating an operation for generating a chapter list using a prompt according to an embodiment;

FIG. 7 is a diagram illustrating a content analyzing model that generates a chapter list according to an embodiment;

FIG. 8 is a diagram illustrating an operation for determining a target chapter according to an embodiment;

FIG. 9 is a diagram illustrating an operation for generating a chapter list without providing a prompt according to an embodiment;

FIG. 10 is a diagram illustrating a content analyzing model that receives content group data as input data according to an embodiment;

FIG. 11 is a diagram illustrating an operation for generating a chapter list according to an embodiment;

FIG. 12 is a diagram illustrating an operation for updating a profile according to an embodiment;

FIG. 13 is a diagram illustrating a detailed operation for generating a chapter list according to an embodiment;

FIG. 14 is a diagram illustrating an operation for obtaining script information according to an embodiment;

FIG. 15 is a diagram illustrating content group data according to an embodiment;

FIG. 16 is a diagram illustrating a profile according to an embodiment;

FIG. 17 is a diagram illustrating a prompt according to an embodiment;

FIG. 18 is a diagram illustrating scene group data according to an embodiment;

FIG. 19 is a diagram illustrating chapter group data according to an embodiment;

FIG. 20 is a diagram illustrating a chapter list according to an embodiment;

FIG. 21 is a diagram illustrating an operation for generating a chapter list in a server according to an embodiment;

FIG. 22 is a diagram illustrating an operation for performing a chapter function using a plurality of external devices according to an embodiment; and

FIG. 23 is a diagram illustrating a controlling method of an electronic apparatus according to an embodiment.

### DETAILED DESCRIPTION

The disclosure will be described in detail below with reference to the accompanying drawings.

Terms used in describing the embodiments of the disclosure are general terms selected that are currently widely used considering their function herein. However, the terms may change depending on intention, legal or technical interpretation, emergence of new technologies, and the like of those skilled in the related art. Further, in certain cases, there may be terms arbitrarily selected, and in this case, the meaning of the term will be disclosed in greater detail in the corresponding description. Accordingly, the terms used herein are not to be understood simply as its designation but based on the meaning of the term and the overall context of the disclosure.

In the disclosure, expressions such as “have,” “may have,” “include,” and “may include” are used to designate a presence of a corresponding characteristic (e.g., elements such as numerical value, function, operation, or component), and not to preclude a presence or a possibility of additional characteristics.

Expressions such as “at least one of A and B”, “at least one of A, and B”, “at least one of A or B”, “at least one of A, or B”, “at least one of A and/or B”, “at least one of A, and/or B”, as used herein, includes any of the following: A, B, A and B. Similarly, expressions such as “at least one of A, B and C”, “at least one of A, B, and C”, “at least one of A, B or C”, at least one of A, B, or C”, “at least one of A, B and/or C”, “at least one of A, B, and/or C”, as used herein, includes any of the following: A, B, C, A and B, A and C, B and C, A and B and C. Moreover, language such as “at least one from among” has a same meaning as the expression “at least one of” as described above. For example, the expression “at least one from among A or B” has a same meaning as “at least one of A or B”.

Expressions such as “1st”, “2nd”, “first”, or “second” used in the disclosure may limit various elements regardless of order and/or importance, and may be used merely to distinguish one element from another element and not limit the relevant element.

When a certain element (e.g., a first element) is indicated as being “(operatively or communicatively) coupled with/to” or “connected to” another element (e.g., a second element), it may be understood as the certain element being directly coupled with/to the another element or as being coupled through other element (e.g., a third element).

A singular expression includes a plural expression, unless otherwise specified. It is to be understood that the terms such as “configured” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

The term “module” or “part” used in the embodiments herein perform at least one function or operation, and may be implemented with a hardware or software, or implemented with a combination of hardware and software. In addition, a plurality of “modules” or a plurality of “parts”, except for a “module” or a “part” which needs to be implemented with a specific hardware, may be integrated in at least one module and implemented as at least one processor.

In the disclosure, the term “user” may refer to a person using an electronic apparatus or an apparatus (e.g., artificial intelligence electronic apparatus) using the electronic apparatus.

An embodiment of the disclosure will be described in greater detail below with reference to the accompanied drawings.

An artificial intelligence system may be a computer system that implements intelligence of a human level, and may be a system in which a machine learns and determines on its own, and a recognition rate thereof is improved with use.

An artificial intelligence technology may be configured with element technologies that simulate functions such as recognition, determination, and the like of a human brain by utilizing machine learning (deep learning) technology and machine learning algorithms which use an algorithm for classifying/learning features of the input data.

Element technologies may include at least one from among, for example, linguistic understanding technology for recognizing human languages/characters, visual understanding technology for recognizing objects like human vision, inference/prediction technology for inferring and predicting by logically determining information, knowledge representation technology for processing human experience information as knowledge data, and motion control technology for controlling autonomous driving of vehicles and movements of robots.

In the disclosure, an artificial intelligence model being trained may mean a pre-defined operation rule set to perform a desired characteristic (or, objective) or an artificial intelligence model being created as a basic artificial intelligence model (e.g., an artificial intelligence model that includes a random parameter) is trained by a learning algorithm using a plurality of training data. The training may be carried out through a separate server and/or system, but is not limited thereto, and may be carried out in the electronic apparatus 100. Examples of the learning algorithm may include a supervised learning, an unsupervised learning, a semi-supervised learning, a transfer learning, or a reinforcement learning, but is not limited to the above-described examples.

Here, each artificial intelligence model may be implemented as, for example, and without limitation, a Convolutional Neural Network (CNN), a Recurrent Neural Network (RNN), a Restricted Boltzmann Machine (RBM), a Deep Belief Network (DBN), a Bidirectional Recurrent Deep Neural Network (BRDNN), a Deep-Q Networks, and the like, and is not limited to thereto.

A processor 120 for executing an artificial intelligence model according to an embodiment of the disclosure may be implemented through a combination of a generic-purpose processor such as a central processing unit (CPU), an application processor (AP), a digital signal processor (DSP), and the like, a graphics dedicated processor such as a graphics processing unit (GPU) and a vision processing unit (VPU), or an artificial intelligence dedicated processor such as a neural processing unit (NPU) and software. The processor 120 may control to process input data according to the predefined operation rule or the artificial intelligence model stored in a memory 110. Alternatively, if the processor 120 is a dedicated processor (or the artificial intelligence dedicated processor), the processor 120 may be designed in a hardware structure which specializes in processing a specific artificial intelligence model. For example, the hardware specializing in the processing of the specific artificial intelligence model may be designed as a hardware chip such as an application-specific integrated circuit (ASIC) and a field programmable gate array (FPGA). If the processor 120 is implemented as a dedicated processor, the processor 120 may be implemented to include a memory for implementing embodiments of the disclosure, or implemented to include a memory processing function for using an external memory.

According to another example, the memory 110 may store information on the artificial intelligence model that includes a plurality of layers. Here, the storing information on the artificial intelligence model may mean storing various information associated with an operation of the artificial intelligence model such as, for example, and without limitation, information on the plurality of layers included in the artificial intelligence model, information on a parameter (e.g., a filter coefficient, a bias, etc.) used in each of the plurality of layers, and the like.

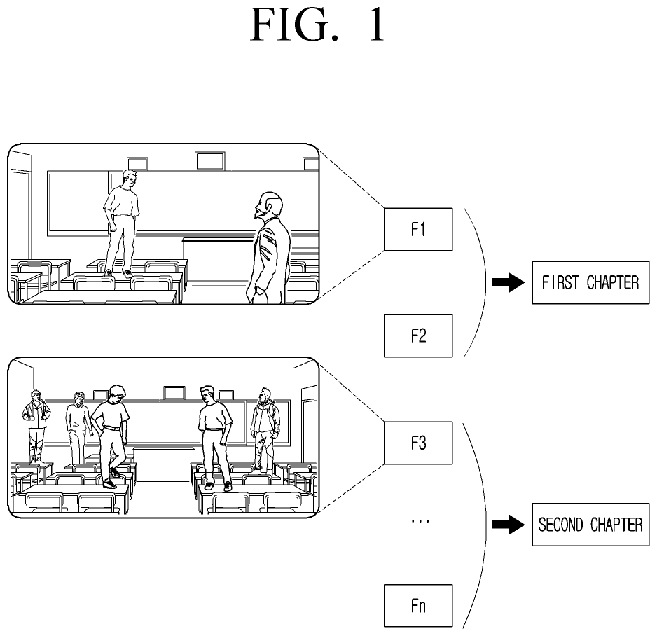

FIG. 1 is a diagram illustrating a content chapter function according to an embodiment.

Referring to FIG. 1, the electronic apparatus 100 may perform a content chapter function. The content chapter function may include an operation for categorizing content based on a specific chapter. A chapter may refer to a unit section defined by dividing content by topic or section. A chapter may include a section classified by topic or a section corresponding to a user input (or selection).

The content chapter function may include an operation for categorizing by theme with respect to a determined section from among a whole section of content, and an operation for providing a section corresponding to a user input (or selection).

In an example, content may include a moving image. If a whole section of the moving image is categorized by theme, a user may easily view a desired specific section without having to view the whole moving image.

It may be assumed that the content includes a plurality of frames F1, F2, F3, . . . , Fn. The electronic apparatus 100 may perform the content chapter function, and categorize the plurality of frames by chapter. The electronic apparatus 100 may determine a portion of the frames F1 and F2 as a first chapter. The electronic apparatus 100 may determine a portion of the frames F3, . . . , Fn as a second chapter.

The content chapter function may be described as a section categorizing function, a section managing function, a content dividing function, a search function by theme, a bookmark generating function, and the like.

The chapter may indicate a specific theme or a specific section.

With respect to a specific theme, the chapter may be described as a topic, an incident, a theme, an issue, an item, a perspective, and the like.

With respect to a specific section, the chapter may be described as a section, a part, an episode, a paragraph, a parcel, and the like.

The electronic apparatus 100 may classify a chapter based on a specific theme.

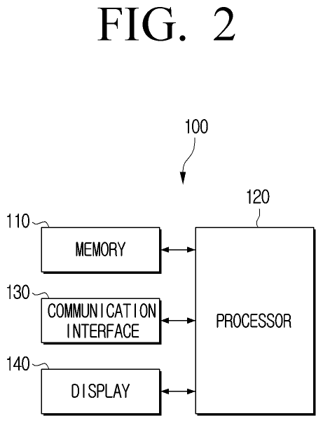

FIG. 2 is a block diagram illustrating the electronic apparatus 100 according to an embodiment.

Referring to FIG. 2, the electronic apparatus 100 may include the memory 110 that stores instructions and at least one processor 120 that includes processing circuitry.

The at least one processor 120 may obtain content source data that includes image data and audio data. The content source data may be described as content data. The content data may include media data. The content data may include at least one of image data or audio data. In one example, content data may include both image data and audio data. The content data may be described as media information, content information, multimedia data, or a content data group.

The at least one processor 120 may obtain the content source data stored in the memory 110. The image data may include a plurality of image frames. The image data and the audio data may be matched based on time (or time-point).

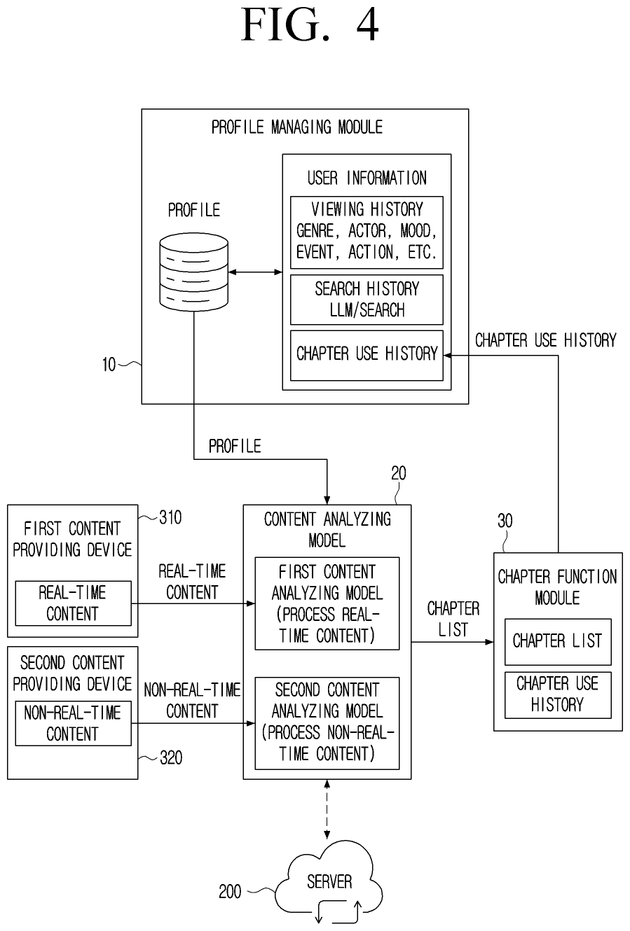

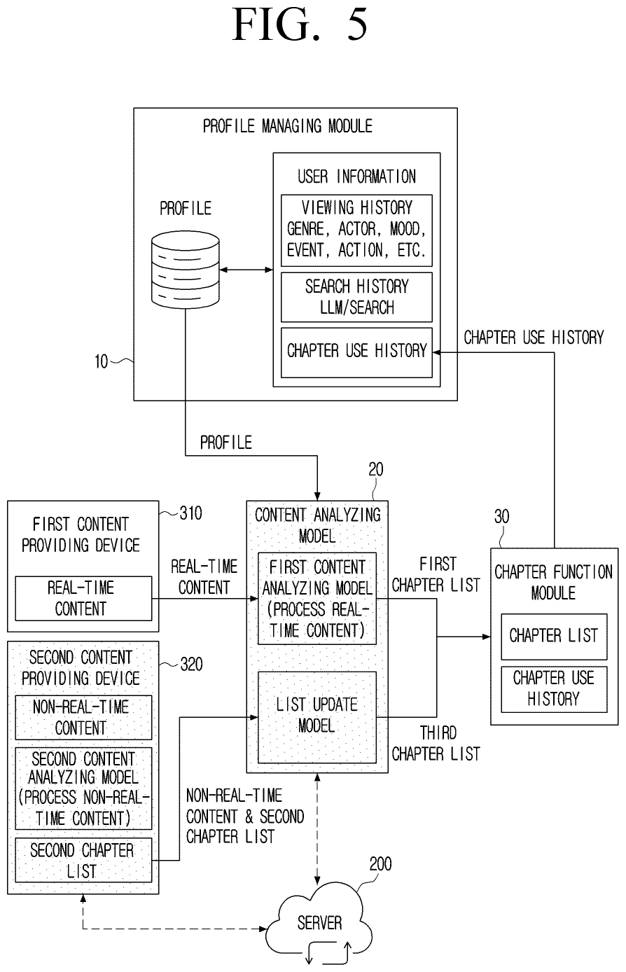

In an example, the at least one processor 120 may receive the content source data from a content providing device. The content providing device may be a device that provides at least one content. The at least one content may be classified as a real-time content or a non-real-time content according to whether content is provided in real-time. Descriptions associated therewith will be described in FIG. 4 and FIG. 5.

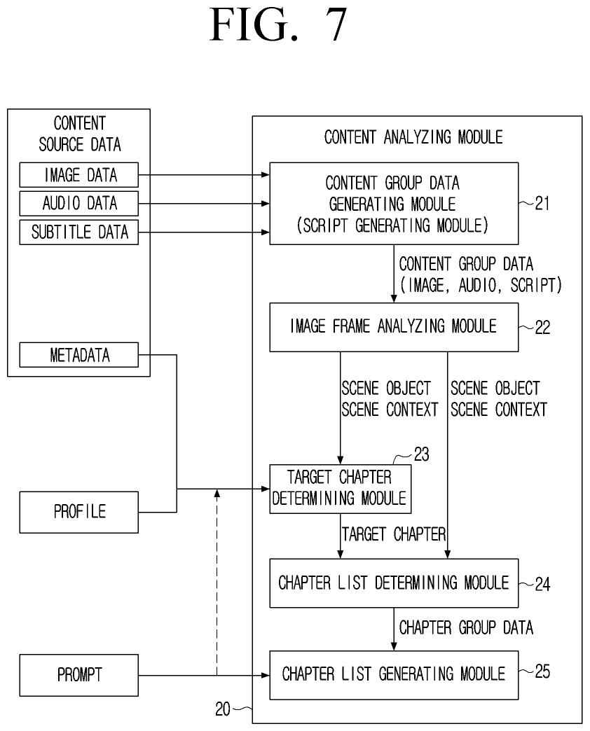

In an example, the content source data may include at least one from among image data, audio data, subtitle data, or metadata. Descriptions associated therewith will be described in FIG. 7.

The at least one processor 120 may obtain, based on a user input (a first user input) for performing the chapter function for classifying the plurality of image frames included in the image data based on a pre-set theme being received, a profile and a prompt corresponding to the user.

The chapter function may be a function that categorizes the plurality of image frames based on a determined theme (or standard). Descriptions associated the chapter function will be described in FIG. 1.

The profile may include weight value information indicating priority with respect to context. The profile may be information generated based on user information. The profile may be described as profile data, profile information, or the like. The profile may refer to information indicating characteristics and states of a specific subject (e.g., a user, a system, or content). A profile may be described as a user data group, attribute data, characteristic information, or user usage information.

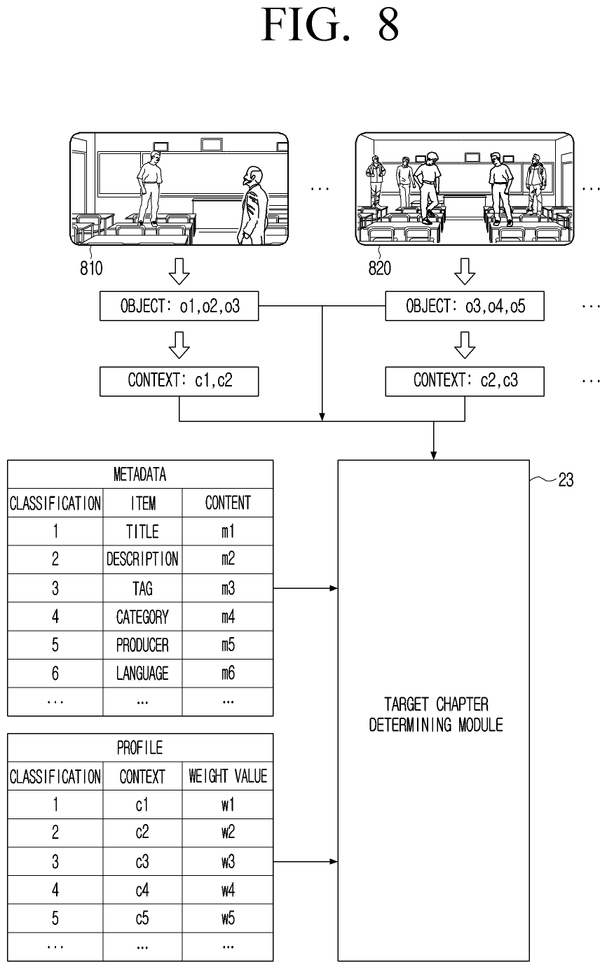

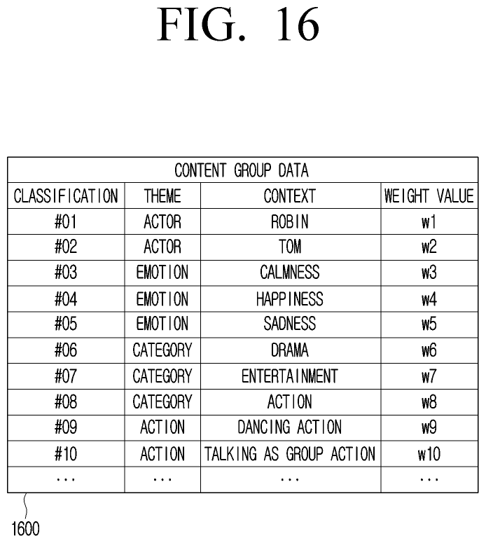

The profile may be generated based on user information indicating a use history of the content. The user information may include at least one from among a viewing history, a search history, or a chapter use history. Descriptions associated therewith will be described in FIG. 7 and FIG. 8. An example of the profile will be described in FIG. 16.

The prompt may include a condition for generating a chapter list. The prompt may refer to an input, condition, command, or instruction presented to induce a specific operation or response. The prompt may be an input signal provided in the form of text, command, description, or example, for allowing a system or model to generate a result or perform an operation.

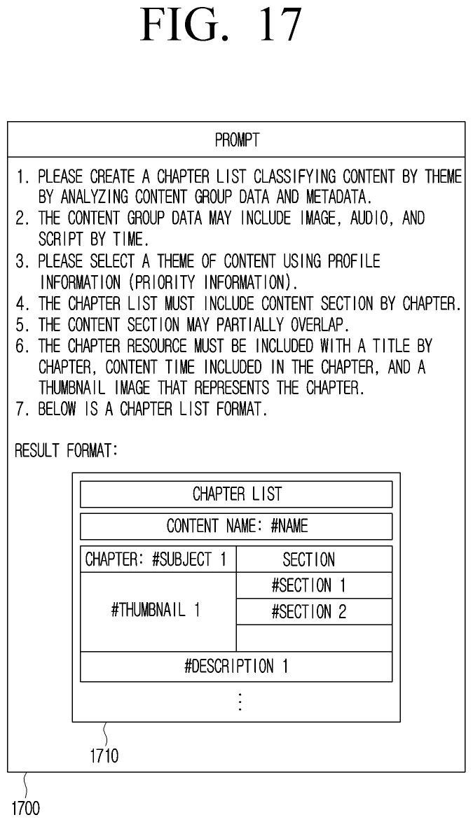

The prompt may include an input text or an input command which is used by a model to generate a response. The prompt may include at least one from among a condition (or a command), a description, or an example. The prompt may be changed according to a setting by the user. The prompt may be changed (or updated) based on pre-set information. The prompt may be information assisting to generate an appropriate response based on data trained by the model. The prompt may be used in an operation for determining a parameter or an output process for the model to generate output data. An example of the prompt will be described in FIG. 17.

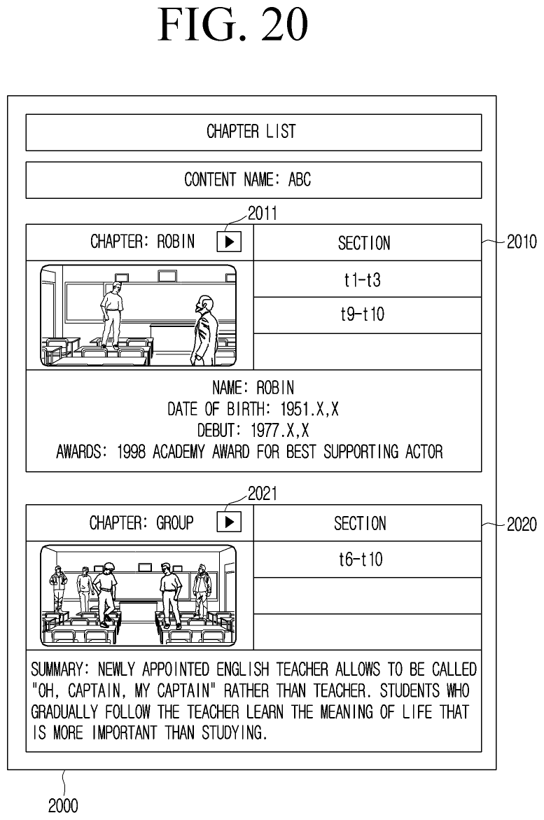

The at least one processor 120 may identify a target chapter indicating a pre-set theme based on the content source data, the profile, and the prompt. When the target chapter is identified, the at least one processor 120 may identify a target frame corresponding to the target chapter. The at least one processor 120 may provide the chapter list including the target chapter and the target frame. Description of the chapter list will be described in FIG. 20.

In an example, the target chapter may be in plurality. The target chapter may indicate a specific theme. The target chapter may indicate a chapter that is determined based on a user preference from among a plurality of chapters. There is a need for the chapter function to be performed based on the specific theme preferred by the user. A theme corresponding to the user preference from among a plurality of themes may be determined as the target chapter.

An operation for determining the target chapter and the target frame will be described in FIG. 7.

An operation for determining the target chapter will be described in FIG. 8.

The at least one processor 120 may identify a scene object included a plurality of image frames. The at least one processor 120 may identify a scene context included in the plurality of image frames based on the scene object. The at least one processor 120 may determine the target chapter based on the profile, the prompt, the scene object, and the scene context.

The scene object may indicate an object that is identified in a frame. The scene object may indicate an independently identifiable object in the content.

The scene context may indicate background elements that indicate an environment or situation surrounding an object in content.

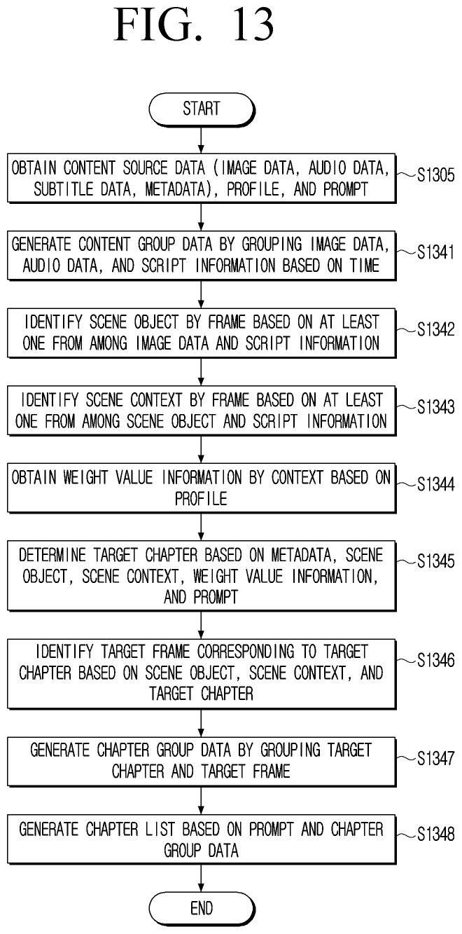

An operation for identifying the scene object and the scene context will be described in FIG. 13.

The at least one processor 120 may obtain script information indicating a content gist based on the content source data.

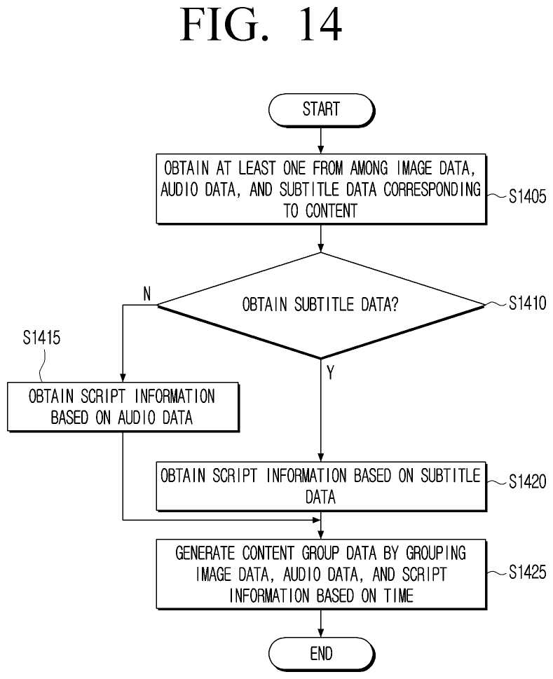

The script information may include information indicating the content gist. The script information may include a text indicating lines or a dialogue. An operation for obtaining the script information may be described in FIG. 14.

In an example, the at least one processor 120 may identify at least one from among the scene object or the scene context based on the script information.

In an example, the at least one processor 120 may identify the scene object based on at least one from among the image data or the script information.

In an example, the at least one processor 120 may identify the scene context based on at least one from among the image data, the script information, and the scene object.

The at least one processor 120 may identify a target frame corresponding to the target chapter from among a plurality of image frames based on the scene object and the scene context.

The at least one processor 120 may obtain a representative object and a representative context corresponding to the target chapter. The at least one processor 120 may obtain a first similarity of the representative object and the scene object. The at least one processor 120 ma obtain a second similarity of the representative context and the scene context.

The at least one processor 120 may identify a target frame corresponding to the target chapter from among the plurality of image frames based on at least one from among the first similarity or the second similarity.

In an example, if the first similarity is greater than or equal to a first threshold value, the at least one processor 120 may determine an image frame that includes the scene object corresponding to the first similarity as the target frame.

In an example, if the second similarity is greater than or equal to a second threshold value, the at least one processor 120 may determine an image frame including the scene context corresponding to the second similarity as the target frame.

In an example, if the first similarity is greater than or equal to the first threshold value and the second similarity is greater than or equal to a second threshold value, the at least one processor 120 may determine an image frame that includes both the scene object corresponding to the first similarity and the scene context corresponding to the second similarity as the target frame.

The at least one processor 120 may update the profile based on at least one from among the content viewing history, the content search history, or the chapter use history.

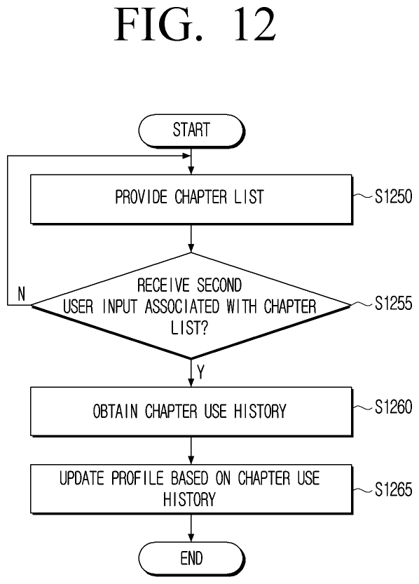

The user input may be a first user input, and the at least one processor 120 may obtain, based on a second user input selecting the chapter list being received, the chapter use history based on the second user input. The at least one processor 120 may update the profile based on the chapter use history. Descriptions associated therewith will be described in FIG. 12.

The at least one processor 120 may obtain the chapter list by inputting the content source data, the profile, and the prompt in a content analyzing model 20. In an example, the content analyzing model 20 may include a large language model (LLM).

The content analyzing model 20 may include an artificial intelligence model. The content analyzing model 20 may include an artificial intelligence model trained for content analysis. The content analyzing model 20 may include an artificial intelligence model corresponding to content analysis.

The content analyzing model 20 may include a machine trained (machine learned) artificial intelligence model. In an example, the machine training (machine learning) may include deep learning or LLM.

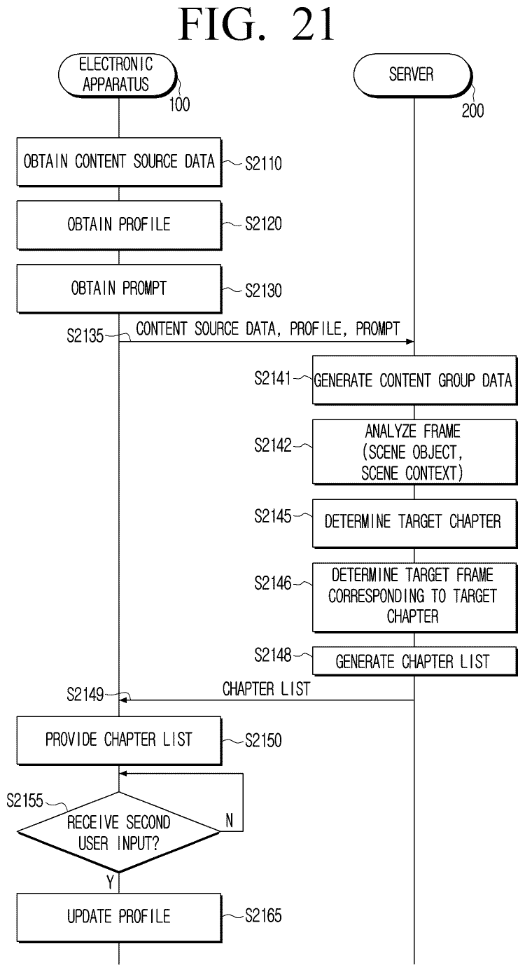

Descriptions of the content analyzing model 20 will be described in FIG. 4 to FIG. 10. Description of a device that includes the content analyzing model 20 will be described in FIG. 21.

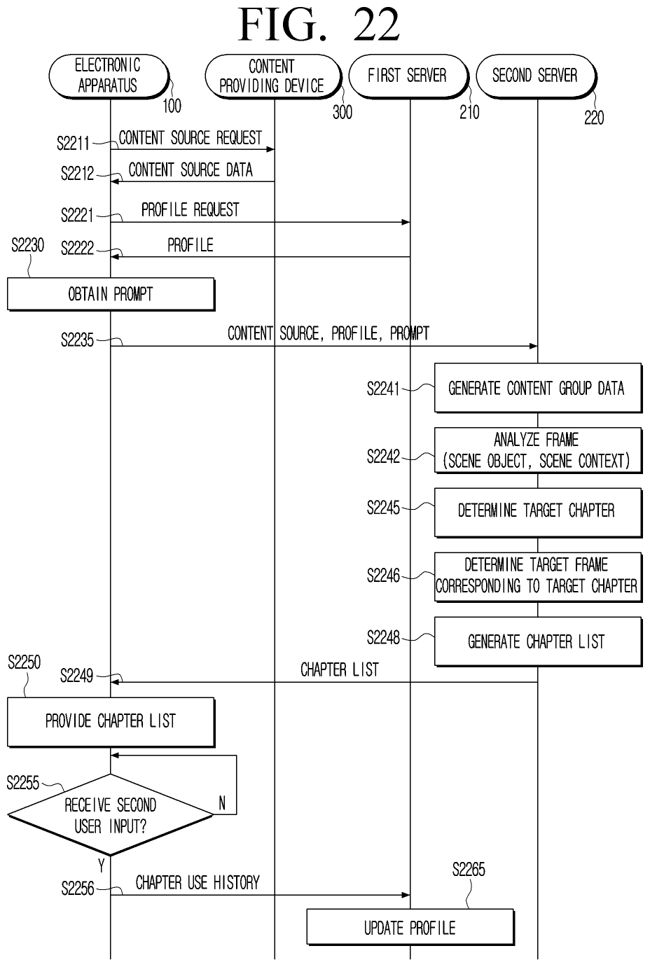

An embodiment requesting the profile to an external server will be described in FIG. 22.

The electronic apparatus 100 may generate the chapter list using the profile indicating the user preference and the prompt indicating a condition for providing the chapter list suitable to the user. When generating the chapter list using the profile or the prompt, a categorization suitable to the user may be provided.

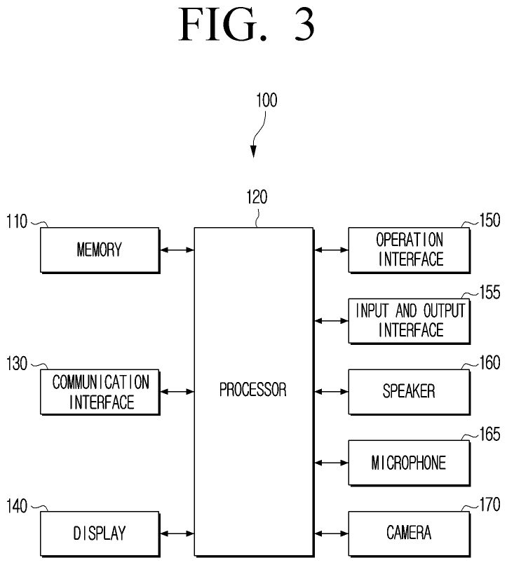

FIG. 3 is a block diagram illustrating a detailed configuration of the electronic apparatus 100 in FIG. 2 according to an embodiment.

Referring to FIG. 3, the electronic apparatus 100 may include at least one from among the memory 110, the at least one processor 120, a communication interface 130, a display 140, an operation interface 150, an input and output interface 155, a speaker 160, a microphone 165, and a camera 170.

The memory 110 may be implemented as an internal memory such as, for example, and without limitation, a read only memory (ROM) (e.g., an electrically erasable programmable read-only memory (EEPROM)), a random access memory (RAM), and the like included in the at least one processor 120, or implemented as a memory separate from the at least one processor 120. The memory 110 may be implemented in a form of a memory embedded in the electronic apparatus 100 according to data storage use, or implemented as a form of a memory attachable to or detachable from the electronic apparatus 100. For example, data for driving the electronic apparatus 100 may be stored in the memory embedded in the electronic apparatus 100, and data for an expansion function of the electronic apparatus 100 may be stored in the memory attachable to or detachable from the electronic apparatus 100.

The memory embedded in the electronic apparatus 100 may be implemented as at least one from among a volatile memory (e.g., a dynamic RAM (DRAM), a static RAM (SRAM), or a synchronous dynamic RAM (SDRAM)), or a non-volatile memory (e.g., a one time programmable ROM (OTPROM), a programmable ROM (PROM), an erasable and programmable ROM (EPROM), an electrically erasable and programmable ROM (EEPROM), a mask ROM, a flash ROM, a flash memory (e.g., NAND flash or NOR flash), a hard disk drive (HDD) or a solid state drive (SSD)), and the memory attachable to or detachable from the electronic apparatus 100 may be implemented in a form such as, for example, and without limitation, a memory card (e.g., a compact flash (CF), a secure digital (SD), a micro secure digital (micro-SD), a mini secure digital (mini-SD), an extreme digital (xD), a multi-media card (MMC), etc.), an external memory (e.g., a universal serial bus (USB) memory) connectable to a USB port, or the like.

The memory 110 may store at least one instruction. The at least one processor 120 may perform various operations based on the instructions stored in the memory 110.

The at least one processor 120 may be implemented as the DSP for processing a digital image signal, a microprocessor, or a time controller (TCON). However, the embodiment is not limited thereto, and may include one or more from among the CPU, a micro controller unit (MCU), a micro processing unit (MPU), a controller, the AP, a communication processor (CP), or an advanced reduced instruction set computer (RISC) machines (ARM) processor, or may be defined by the relevant term. The at least one processor 120 may be implemented as a System on Chip (SoC) or a large scale integration (LSI) in which a processing algorithm is embedded, and may be implemented in a form of a field programmable gate array (FPGA). The at least one processor 120 may perform various functions by executing computer executable instructions stored in the memory.

The communication interface 130 may be a configuration for performing communication with external devices of various types according communication methods of various types. The communication interface 130 may include a wireless communication module or a wired communication module. Each communication module may be implemented in at least one hardware chip form.

The wireless communication module may be a module for communicating with the external device via wireless communication. For example, the wireless communication module may include at least one module from among a Wi-Fi module, a Bluetooth module, an infrared communication module, or other communication modules.

The Wi-Fi module and the Bluetooth module may perform communication in a Wi-Fi method and a Bluetooth method, respectively. When using the Wi-Fi module or the Bluetooth module, various connection information such as a service set identifier (SSID) and a session key may first be transmitted and received, and various information may be transmitted and received after communicatively connecting using the same.

The infrared communication module may perform communication according to an infrared communication (Infrared Data Association (IrDA)) technology of transmitting data wirelessly in short range by using infrared rays present between visible rays and millimeter waves.

The other communication modules may include at least one communication chip that performs communication according to various wireless communication standards such as, for example, and without limitation, ZigBee, 3rd Generation (3G), 3rd Generation Partnership Project (3GPP), Long Term Evolution (LTE), LTE Advanced (LTE-A), 4th Generation (4G), 5th Generation (5G), and the like, in addition to the above-described communication methods.

The wired communication module may be a module for communicating with an external device via wired communication. For example, the wired communication module may include at least one from among a local area network (LAN) module, an Ethernet module, a pair cable, a coaxial cable, an optical fiber cable, or an ultra wide-band (UWB) module.

According to an embodiment, the communication interface 130 may use the same communication module (e.g., Wi-Fi module) for communicating with an external device such as a remote control device and an external server.

According to an embodiment, the communication interface 130 may use different communication modules for communicating with the external device such as the remote control device and the external server. For example, the communication interface 130 may use at least one from among the Ethernet module or the Wi-Fi module to communicate with the external server, or use the Bluetooth module to communicate with the external device such as the remote control device. However, the above is merely one embodiment, and the communication interface 130 may use at least one communication module from among various communication modules when communicating with a plurality of external devices or external servers.

The display 140 may be implemented as displays of various forms such as, for example, and without limitation, a liquid crystal display (LCD), an organic light emitting diode (OLED) display, a plasma display panel (PDP), and the like. In the display 140, a driving circuit, which may be implemented in a form of an amorphous silicon thin film transistor (a-si TFT), a low temperature poly silicon (LTPS) TFT, an organic TFT (OTFT), or the like, a backlight unit, and the like may be included. The display 140 may be implemented as a touch screen coupled with a touch sensor, a flexible display, a three-dimensional display (3D display), or the like. According to an embodiment of the disclosure, the display 140 may include, not only a display panel that outputs images, but also a bezel that houses the display panel. Specifically, according to an embodiment of the disclosure, the bezel may include a touch sensor for sensing a user interaction.

The operation interface 150 may be implemented as device such as a button, a touch pad, a mouse, and a keyboard, or implemented as a touch screen capable of performing the above-described display function and an operation input function together therewith. The button may be buttons of various types such as a mechanical button, a touch pad, or a wheel which is formed at a random area at a front surface part or a side surface part, a rear surface part, or the like of an exterior of a main body of the electronic apparatus 100.

The input and output interface 155 may be any one interface from among a High Definition Multimedia Interface (HDMI), a Mobile High-Definition Link (MHL), the USB, a Display Port (DP), Thunderbolt, a Video Graphics Array (VGA) port, an RGB port, a D-subminiature (D-SUB), or a Digital Visual Interface (DVI). The input and output interface 155 may input and output at least one from among an audio signal and a video signal. According to an embodiment, the input and output interface 155 may include a port that inputs and outputs only audio signals and a port that inputs and outputs only video signals as separate ports, or may be implemented as one port that inputs and outputs both the audio signals and the video signals. The electronic apparatus 100 may transmit at least one from among the audio signals or the video signals to an external device (e.g., an external display device or an external speaker) through the input and output interface 155. An output port included in the input and output interface 155 may be connected with the external device, and the electronic apparatus 100 may transmit at least one from among the audio signals and the video signals to the external device through the output port.

The input and output interface 155 may be connected with the communication interface. The input and output interface 155 may transmit information received from an external device to the communication interface or transmit information received through the communication interface to an external device.

The speaker 160 may be an element which outputs not only various audio data, but also various notification sounds, voice messages, or the like.

The microphone 165 may be a configuration for receiving input of a user voice or other sounds and converting to audio data. The microphone 165 may receive the user voice in an activated state. For example, the microphone 165 may be formed as an integrated-type at an upper side or a front surface direction, a side surface direction or the like of the electronic apparatus 100. The microphone 165 may include various configurations such as, for example, and without limitation, a microphone that collects the user voice in an analog form, an amplifier circuit that amplifies the collected user voice, an A/D converter circuit that samples the amplified user voice and converts to a digital signal, a filter circuit that removes noise components from the converted digital signal, and the like.

The camera 170 may be a configuration for generating a captured image by capturing a subject, and the captured image may be a concept that includes both a moving image and a still image. The camera 170 may obtain an image of at least one external device, and may be implemented with a camera, a lens, an infrared sensor, and the like.

The camera 170 may include a lens and an image sensor. Types of lenses may include a typically generic-purpose lens, a wide-angle lens, a zoom lens, and the like, and the lens may be determined according to a type, a characteristic, use environment and the like of the electronic apparatus 100. As an image sensor, a Complementary Metal Oxide Semiconductor (CMOS) and a Charge Coupled Device (CCD), and the like may be used.

According to an embodiment, the electronic apparatus 100 may include the display 140. The electronic apparatus 100 may directly display an obtained image or content on the display 140.

According to an embodiment, the electronic apparatus 100 may not include the display 140. The electronic apparatus 100 may be connected with an external display device, and transmit the image or content stored in the electronic apparatus 100 to the external display device.

The electronic apparatus 100 may transmit an image or content together with a control signal for controlling for the image or content to be displayed in the external display device to the external display device. The external display device may be connected with the electronic apparatus 100 through the communication interface 130 or the input and output interface 155. For example, the electronic apparatus 100 may not include the display as in a set top box (STB).

The electronic apparatus 100 may include only a small-scale display with which only simple information such as text information can be displayed. The electronic apparatus 100 may transmit the image or content to the external display device via wired or wireless means through the communication interface 130, or transmit the same to the external display device through the input and output interface 155.

There may be an embodiment of the electronic apparatus 100 performing an operation corresponding to a user voice signal received through the microphone 165.

According to an embodiment, the electronic apparatus 100 may control the display 140 based on the user voice signal received through the microphone 165. For example, if a user voice signal for displaying content A is received, the electronic apparatus 100 may control the display 140 to display content A.

According to an embodiment, the electronic apparatus 100 may control the external display device that is connected with the electronic apparatus 100 based on the user voice signal received through the microphone 165. The electronic apparatus 100 may generate a control signal for controlling the external display device for an operation corresponding to the user voice signal to be performed in the external display device, and transmit the generated control signal to the external display device. The electronic apparatus 100 may store a remote control application for controlling the external display device. Then, the electronic apparatus 100 may transmit the generated control signal to the external display device using at least one communication method from among Bluetooth, Wi-Fi, or Infrared. For example, when the user voice signal for displaying content A is received, the electronic apparatus 100 may transmit the control signal for controlling for content A to be displayed in the external display device to the external display device. The electronic apparatus 100 may mean various terminal devices in which remote control applications can be installed such as a smartphone, an artificial intelligence (AI) speaker, and the like.

According to an embodiment, the electronic apparatus 100 may use the remote control device to control the external display device connected with the electronic apparatus 100 based on the user voice signal received through the microphone 165. The electronic apparatus 100 may transmit the control signal for controlling the external display device to the remote control device for an operation corresponding to the user voice signal to be performed in the external display device. Then, the remote control device may transmit the control signal received from the electronic apparatus 100 to the external display device. For example, when the user voice signal for displaying content A is received, the electronic apparatus 100 may transmit the control signal for controlling content A to be displayed in the external display device to the remote control device, and the remote control device may transmit the received control signal to the external display device.

The electronic apparatus 100 may receive the user voice signal through various methods.

According to an embodiment, the electronic apparatus 100 may receive the user voice signal through the microphone 165 included in the electronic apparatus 100.

According to an embodiment, the electronic apparatus 100 may receive the user voice signal from the external device that includes the microphone. The external device may mean a remote control device, a smartphone, or the like. The received user voice signal may be a digital voice signal, but may be an analog voice signal according to an embodiment. The electronic apparatus 100 may receive the user voice signal through wireless communication methods such as Bluetooth or Wi-Fi.

The electronic apparatus 100 may convert the user voice signal with various methods.

According to an embodiment, the electronic apparatus 100 may obtain text information corresponding to the user voice signal from the external server. The electronic apparatus 100 may transmit the user voice signal (audio signal or digital signal) to the external server. The external server may mean a voice recognition server. The voice recognition server may convert the user voice signal to text information using Speech To Text (STT). Then, the external server may transmit text information corresponding to the converted user voice signal to the electronic apparatus 100.

According to an embodiment, the electronic apparatus 100 may obtain text information corresponding to the user voice signal on its own. The electronic apparatus 100 may directly apply a Speech To Text (STT) function to a digital voice signal converting to text information, and transmit the converted text information to the external server.

The external server may transmit information to the electronic apparatus 100 through various methods.

According to an embodiment, the external server may transmit text information corresponding to the user voice signal to the electronic apparatus 100. The external server may be a server that performs a voice recognition function of converting the user voice signal to text information.

According to an embodiment, the external server may transmit at least one from among the text information corresponding to the user voice signal or search result information corresponding to the text information to the electronic apparatus 100. The external server may be a server that performs a search result providing function of providing search result information corresponding to the text information in addition to the voice recognition function of converting the user voice signal to the text information. In an example, the external server may be a server that performs both the voice recognition function and the search result providing function. In another example, the external server may perform only the voice recognition function and the search result providing function may be performed in a separate server. The external server may transmit the text information to a separate server to obtain a search result and obtain the search result corresponding to the text information from the separate server.

The electronic apparatus 100 may communicatively connect with the external device and the external server through various methods.

According to an embodiment, communication modules for communicating with the external device and the eternal server may be implemented identically. For example, the electronic apparatus 100 may communicate with the external device using the Bluetooth module, as well as also communicating with the external server using the Bluetooth module.

According to an embodiment, communication modules for communicating with the external device and the eternal server may be implemented separately. For example, the electronic apparatus 100 may communicate with the external device using the Bluetooth module, and communicate with the external server using an Ethernet modem or the Wi-Fi module.

FIG. 4 is a diagram illustrating an operation for generating a chapter list according to an embodiment.

Referring to FIG. 4, the electronic apparatus 100 may provide the chapter list using at least one from among a profile managing module 10, the content analyzing model 20, or a chapter function module 30.

The profile managing module 10 may manage a profile based on user information.

The user information may include at least one from among the viewing history, the search history, or the chapter use history. The viewing history may include a history of a content viewing by the user. The search history may include a history of a content search by the user. The chapter use history may include a history of viewed content through the chapter list.

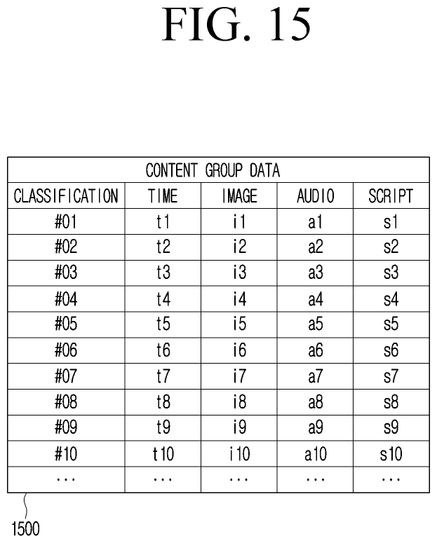

The profile may include information on a context associated with the content preferred by the user. The profile may include weight value information indicating priority with respect to the context. Description of the profile will be described in FIG. 15.

The profile may be information indicating preference and interest of the user based on a history of viewing, searching, using chapters, and the like by the user.

The profile managing module 10 may generate a profile based on user information. The profile may be dynamically updated according to user action changes. When the user information is updated, the profile managing module 10 may update the profile.

The profile managing module 10 may transmit the profile to the content analyzing model 20.

The electronic apparatus 100 may receive real-time content from a first content providing device 310. The electronic apparatus 100 may receive non-real-time content from a second content providing device 320.

The real-time content may be content provided in real-time of content that is currently in progress. The real-time content may be content that cannot be stored as a whole content. The real-time content may be described as live content. In an example, the real-time content may indicate a broadcast channel program, a streaming content, a live broadcast program, and the like.

The non-real-time content may be content that is pre-stored and is viewable at a time desired by the user. The non-real-time content may be content that can be stored as a whole content. In an example, the non-real-time content may be described as an on-demand content, a custom content, a storage content, and the like.

The content analyzing model 20 may be a model for generating the chapter list. The content analyzing model 20 may be described as a content classification model, a content processing model, a content categorizing model, and the like.

The content analyzing model 20 may include at least one from among a first content analyzing model or a second content analyzing model.

The content analyzing model 20 may generate the chapter list using the content (or content source data) and the profile.

The first content analyzing model may be a model for analyzing the real-time content. The second content analyzing model may be a model for analyzing the non-real-time content.

When the real-time content is received from the first content providing device 310, the electronic apparatus 100 may process the real-time content using the first content analyzing model.

When the non-real-time content is received from the second content providing device 320, the electronic apparatus 100 may receive the non-real-time content using the second content analyzing model.

The content analyzing model 20 may be connected to a server 200. The server 200 may be a model for performing the content chapter function. The server 200 may be described as an AI server or a cloud server.

In an example, the server 200 may include the large language model (LLM). The LLM may be an AI model trained with data of a large-scale. The LLM may be a natural language processing model. The LLM may perform various language based works such as understanding, summarization, translation, dialogue generation, and the like of text.

In an example, the LLM may extract a theme, a keyword, and the like by analyzing a script of a content and determine a standard of categorization.

In an example, the LLM may generate summary information indicating a whole of the content.

In an example, the LLM may generate summary information indicating a portion of a section of the content.

In an example, the LLM may perform a translation function corresponding to a language of the user.

When the chapter list is generated, the content analyzing model 20 may transmit the chapter list to the chapter function module 30.

The chapter function module 30 may receive the chapter list from the content analyzing model 20. The chapter function module 30 may provide the chapter list. The chapter function module 30 may include an application associated with the chapter function. The chapter function module 30 may obtain and store a history of use associated with the chapter function. The chapter function module 30 may transmit the chapter use history to the profile managing module 10.

The profile managing module 10 may receive the chapter use history from the chapter function module 30. When the chapter use history is received, the profile managing module 10 may update the profile.

In FIG. 4, an embodiment of the content analyzing model 20 directly receiving the non-real-time content from the second content providing device 320 has been described. In FIG. 5, an embodiment of the content analyzing model 20 directly receiving the chapter list for the non-real-time content will be described.

FIG. 5 is a diagram illustrating an operation for processing a non-real-time content according to an embodiment.

The profile managing module 10, the content analyzing model 20, the chapter function module 30, the server 200, the first content providing device 310, and the second content providing device 320 in FIG. 5 may correspond to the descriptions in FIG. 4. Redundant descriptions thereof will be omitted.

The content analyzing model 20 may include the first content analyzing model. The first content analyzing model may generate a first chapter list by analyzing the real-time content. The first content analyzing model may transmit the first chapter list to the chapter function module 30.

The second content providing device 320 may include the second content analyzing model for analyzing the non-real-time content. The second content providing device 320 may obtain and store a second chapter list for the non-real-time content.

The second content providing device 320 may transmit the second chapter list to a list update model.

The list update model may receive the second chapter list from the second content providing device 320. The list update model may change the second chapter list to a third chapter list based on the profile. The profile may include priority with respect to context.

The second chapter list may be a list without a personal preference of the user reflected. The list update model may generate the third chapter list by correcting the second chapter list based on the profile transmitted from the profile managing module 10. The list update model may transmit the third chapter list to the chapter function module 30.

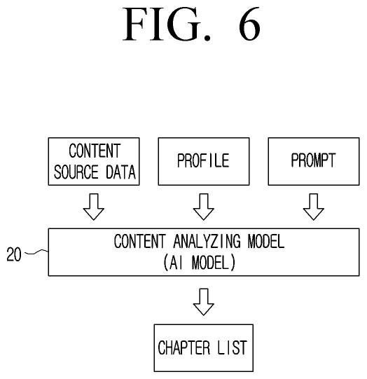

FIG. 6 is a diagram illustrating an operation for generating a chapter list using a prompt according to an embodiment.

Referring to FIG. 6, the content analyzing model 20 may receive at least one from among the content source data, the profile, and the prompt as input data. The content analyzing model 20 may generate the chapter list based on at least one from among the content source data, the profile, and the prompt.

FIG. 7 is a diagram illustrating a content analyzing model that generates a chapter list according to an embodiment.

Referring to FIG. 7, the content analyzing model 20 may receive at least one from among the content source data, the profile, or the prompt.

The content source data may include at least one from among image data, audio data, subtitle data, and metadata.

The image data may include an image signal or an image frame of the content.

The audio data may include an audio signal that is output together with the image data.

The subtitle data may include text information that is output together with the image data and the audio data.

The metadata may include information associated with the content. In an example, the metadata may include at least one from among a title, a description, a tag, a category, a producer, and a language indicating the content.

The content analyzing model 20 may include at least one from among a content group data generating module 21, an image frame analyzing module 22, a target chapter determining module 23, a target frame determining module 24, and a chapter list generating module 25.

The content analyzing model 20 may transmit at least one from among the image data, the audio data, or the subtitle data from among the content source data to the content group data generating module 21.

The content group data generating module 21 may check whether the subtitle data is received.

If the subtitle data is not received, the content group data generating module 21 may generate script information based on the audio data. The content group data generating module 21 may convert the audio data to text data. The content group data generating module 21 may generate the script information based on the text data.

The script information may include a script corresponding to the gist of the content. The script information may include text according to time. The script information may include time-point information associated with sections included in the content and data that matches the text information.

When the subtitle data is received, the content group data generating module 21 may generate script information based on the subtitle data. The subtitle data may be original data included in the content source data. The script information may indicate information converted into a pre-defined format to input the subtitle data in the image frame analyzing module 22. If the subtitle data is present, the content group data generating module 21 may not analyze the audio data separately.

The content group data generating module 21 may match the image data, the audio data, and the script information based on the time-point (or time information). The electronic apparatus 100 may generate the content group data by grouping the image data, the audio data, and the script information based on the time-point. The content group data generating module 21 may transmit the content group data to the image frame analyzing module 22.

The image frame analyzing module 22 may receive the content group data from the content group data generating module 21. The image frame analyzing module 22 may obtain a plurality of frames included in the image data. The image frame analyzing module 22 may identify (or extract) the scene object or scene context by analyzing each of the plurality of frames.

The scene object may indicate an object that is identified in a frame. The scene object may indicate an individual attribute of an object. The scene object may indicate an identifiable independent object or attribute.

The scene context may indicate context that is identified in a frame. The scene context may indicate an environment associated with an object and a correlation with another object. The scene context may indicate an environmental relational background information to understand a frame.

The frame may indicate an image frame.

The image frame analyzing module 22 may generate scene group data that includes the scene object or the scene context based on the received content group data.

The image frame analyzing module 22 may transmit the scene group data to at least one from among the target chapter determining module 23 or the target frame determining module 24.

The target chapter determining module 23 may receive the scene group data from the image frame analyzing module 22. The target chapter determining module 23 may receive metadata included in the content source data. The target chapter determining module 23 may receive the profile.

The target chapter determining module 23 may determine the target chapter based on at least one from among the scene object, the scene context, the metadata, and the profile. The target chapter may indicate a specific theme. The target chapter may be used as a standard for categorizing a specific section from among the whole section of the content.

The target chapter determining module 23 may transmit the target chapter to the target frame determining module 24.

The target frame determining module 24 may receive the target chapter from the target chapter determining module 23. The target frame determining module 24 may receive the scene group data from the image frame analyzing module 22.

The target frame determining module 24 may identify the target frame corresponding to the target chapter from among the whole frame based on at least one from among the scene object and the scene context. The target frame determining module 24 may generate the chapter group data by grouping the target chapter and the target frame. The target frame determining module 24 may transmit the chapter group data to the chapter list generating module 25.

The chapter list generating module 25 may receive the chapter group data from the target frame determining module 24. The chapter list generating module 25 may receive the prompt. The chapter list generating module 25 may generate the chapter list based on the prompt. The prompt may include a condition for generating the chapter list. The chapter list generating module 25 may generate the chapter list based on the condition included in the prompt. In an example, the prompt may include a user interface (UI) condition for providing the chapter list. Descriptions associated therewith will be described in FIG. 17.

FIG. 8 is a diagram illustrating an operation for determining a target chapter according to an embodiment.

Referring to FIG. 8, the electronic apparatus 100 may obtain the content source data. The electronic apparatus 100 may obtain a first frame 810 and a second frame 820 included in the content source data.

The electronic apparatus 100 may identify scene objects o1, o2, and o3 based on the first frame 810. The electronic apparatus 100 may identify scene contexts c1 and c2 based on the scene objects o1, o2, and o3 included in the first frame 810. The electronic apparatus 100 may transmit at least one from among the scene objects o1, o2, and o3 or the scene contexts c1 and c2 to the target chapter determining module 23.

The electronic apparatus 100 may identify scene objects o3, o4, and o5 based on the second frame 820. The electronic apparatus 100 may identify scene contexts c2 and c3 based on the scene objects o3, o4, and o5 included in the second frame 820. The electronic apparatus 100 may transmit at least one from among the scene objects o3, o4, and o5 or the scene contexts c2 and c3 to the target chapter determining module 23.

The electronic apparatus 100 may obtain metadata. The electronic apparatus 100 may transmit the metadata to the target chapter determining module 23.

The electronic apparatus 100 may obtain the profile. The electronic apparatus 100 may transmit the profile to the target chapter determining module 23.

The target chapter determining module 23 may determine the target chapter based on at least one from among a scene object by frame, a scene context by frame, the metadata, and the profile.

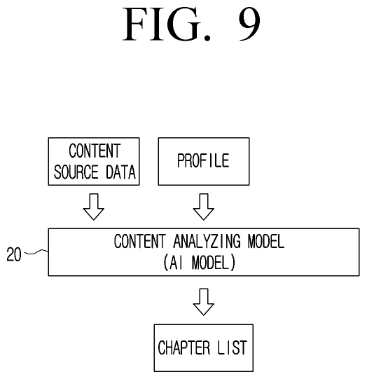

FIG. 9 is a diagram illustrating an operation for generating a chapter list without providing a prompt according to an embodiment.

In FIG. 6, an operation for the content analyzing model 20 receiving the prompt as input data has been described. According to an embodiment in FIG. 9, the content analyzing model 20 may generate the chapter list without having received input of the prompt separately. The content analyzing model 20 may store a pre-defined condition (or format) for generating the chapter list.

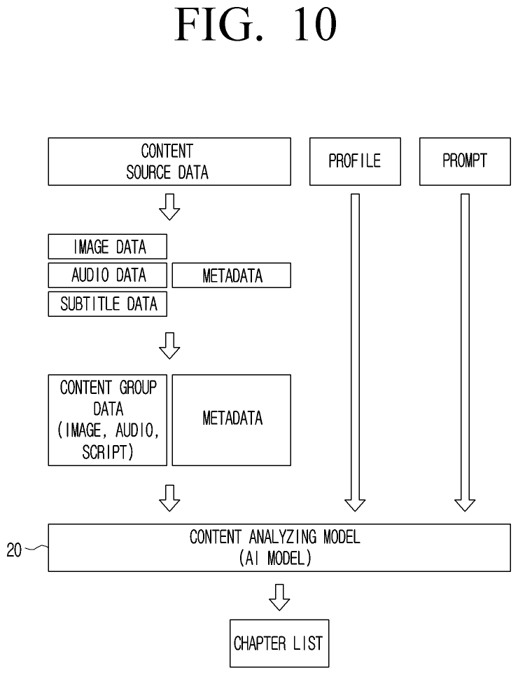

FIG. 10 is a diagram illustrating a content analyzing model that receives content group data as input data according to an embodiment.

In FIG. 7, the content analyzing model 20 has been described as generating the content group data directly. According to an embodiment in FIG. 10, the content analyzing model 20 may not directly generate the content group data. The content analyzing model 20 may receive the content group data as input data.

The electronic apparatus 100 may obtain at least one from among the image data, the audio data, the subtitle data, and the metadata from the content source data.

The electronic apparatus 100 may generate the script information based on at least one from among the audio data and the subtitle data. When the script information is generated, the electronic apparatus 100 may generate the content group data that matches with the image data, the audio data, and the script information.

The electronic apparatus 100 may transmit the content group data and the metadata to the content analyzing model 20. The content analyzing model 20 may obtain at least one from among the content group data, the metadata, the profile, and the prompt as input data. The content analyzing model 20 may generate the chapter list as output data based on the input data.

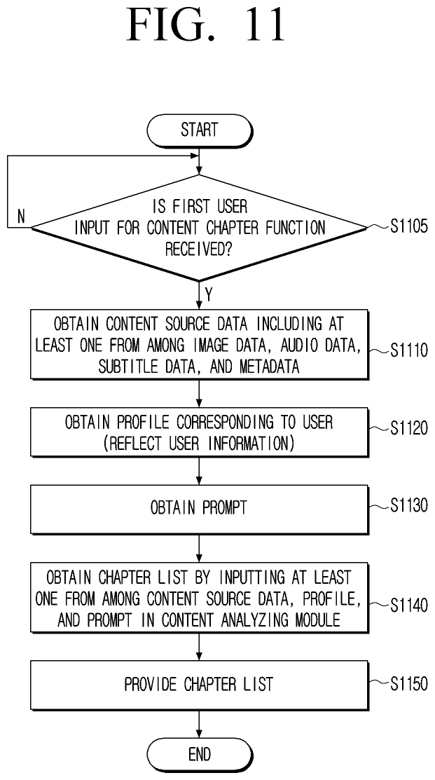

FIG. 11 is a diagram illustrating an operation for generating a chapter list according to an embodiment.

Referring to FIG. 11, the electronic apparatus 100 may identify whether the first user input for the content chapter function is received (S1105-Y). If the first user input for the content chapter function is received (S1105-Y), the electronic apparatus 100 may obtain the content source data that includes at least one from among the image data, the audio data, the subtitle data, and the metadata (S1110).

The electronic apparatus 100 may obtain the profile corresponding to the user (S1120). The profile may be data reflected with user information.

The electronic apparatus 100 may obtain the prompt. The electronic apparatus 100 may obtain the prompt used in obtaining result data from the content analyzing model 20.

In an example, the prompt may be pre-stored data. The content analyzing model 20 may generate the chapter list based on a pre-defined prompt.

In an example, the electronic apparatus 100 may generate the prompt based on the profile. The electronic apparatus 100 may store a basic prompt (a first prompt) in the memory 110. The electronic apparatus 100 may generate (or change) the prompt based on the profile. When the profile is received, the electronic apparatus 100 may obtain a final prompt (a second prompt) by changing the basic prompt (first prompt) based on the profile. The electronic apparatus 100 may identify the user preference using the weight value information by context included in the profile. The electronic apparatus 100 may generate the prompt using the weight value information by context. The electronic apparatus 100 may generate the prompt reflected with the user preference by reflecting the profile in the prompt.

In an example, the content analyzing model 20 may store the prompt.

In an example, the content analyzing model 20 may change the prompt based on the profile.

The electronic apparatus 100 may obtain the chapter list by inputting at least one from among the content source data, the profile, and the prompt in the content analyzing model 20 (S1140).

The electronic apparatus 100 may provide the chapter list (S1150). In an example, the electronic apparatus 100 may display the chapter list through the display 140. In an example, the electronic apparatus 100 may transmit the chapter list to the external device.

The time-points at which the content source data is received may vary.

In an example, operation S1110 may be performed after operation S1105.

In an example, operation S1105 may be performed after operation S1110.

FIG. 12 is a diagram illustrating an operation for updating a profile according to an embodiment.

Operation S1250 in FIG. 12 may correspond to S1150 in FIG. 11. Redundant descriptions thereof will be omitted.

After the chapter list is provided (S1250), the electronic apparatus 100 may identify whether the second user input associated with the chapter list is received (S1255). The second user input may include a user input for selecting one from among a plurality of chapters.

When the second user input is received, the electronic apparatus 100 may obtain the chapter use history (S1260). The electronic apparatus 100 may identify whether the user selected which chapter based on the second user input. When the user selects a specific chapter, the electronic apparatus 100 may obtain the chapter use history indicating that the specific chapter has been selected.

The electronic apparatus 100 may update the profile based on the chapter use history (S1265). The electronic apparatus 100 may repeatedly update the profile by reflecting the selection of the user after providing the chapter list.

FIG. 13 is a diagram illustrating a detailed operation for generating a chapter list according to an embodiment.

Referring to FIG. 13, the content analyzing model 20 may obtain at least one from among the content source data, the profile, and the prompt (S1305). The content source data may include at least one from among the image data, the audio data, the subtitle data, or the metadata.

The content analyzing model 20 may generate the content group data by grouping the image data, the audio data, and the script information based on time (or time-point) (S1341). The script information may include text indicating lines or a dialogue of the gist of the content. A detailed operation associated with the content group data will be described in FIG. 14.

The content analyzing model 20 may identify the scene object by frame based on at least one from among the image data or the script information included in the content group data (S1342). The scene object may indicate an object identified in the image frame.

In an example, the content analyzing model 20 may identify the scene object included in the frame through an image analysis operation with respect to the image data.

In an example, the content analyzing model 20 may determine (or identify) the scene object included in the frame through a text analysis operation with respect to the script information.

In an example, the content analyzing model 20 may identify the scene object included in the frame using both the image data and the script information.

The content analyzing model 20 may identify the scene context by frame based on at least one from among the scene object or the script information (S1343). The scene context may indicate context identified from an image frame.

In an example, the content analyzing model 20 may identify the scene context included in the frame based on the scene object.

In an example, the content analyzing model 20 may identify the scene context included in the frame based on the script information.

In an example, the content analyzing model 20 may identify the scene context included in the frame based on the scene object and the script information.

The content analyzing model 20 may obtain the weight value information by context based on the profile (S1344). Descriptions associated with the weight value information will be described in FIG. 16.

The content analyzing model 20 may determine the target chapter based on at least one from among the metadata, the scene object, the scene context, the weight value information, and the prompt (S1345). The target chapter may be a standard for categorizing the plurality of frames included in the content.

In an example, the content analyzing model 20 may determine the target chapter without the prompt.

In an example, the prompt may include a condition for determining the target chapter. The content analyzing model 20 may determine the target chapter by additionally taking into consideration the prompt.

The content analyzing model 20 may identify the target frame corresponding to the target chapter based on at least one from among the scene object, the scene context, and the target chapter (S1346). The content may include a plurality of frames. The content may include a plurality of image frames. The content analyzing model 20 may identify a frame corresponding to the target chapter from among the plurality of image frames as the target frame.

In an example, the content analyzing model 20 may obtain a representative object that represents the target chapter. The content analyzing model 20 may obtain a first similarity by comparing the representative object with the scene object. The content analyzing model 20 may identify the frame including the scene object with the first similarity being greater than or equal to the first threshold value as the target frame.

In an example, the content analyzing model 20 may obtain a representative context that represents the target chapter. The content analyzing model 20 may obtain a second similarity by comparing the representative context with the scene context. The content analyzing model 20 may identify the frame including the scene context with the second similarity greater than or equal to the second threshold value as the target frame.

In an example, the content analyzing model 20 may identify the frame with the first similarity that is greater than or equal to the first threshold value and with the second similarity that is greater than or equal to the second threshold value as the target frame.

In an example, the target chapter may be in plurality.

The content analyzing model 20 may generate the chapter group data by grouping the target chapter and the target frame (S1347).

In an example, a plurality of frames corresponding to a first target chapter may be present. A plurality of frames corresponding to the second target chapter may be present.

The content analyzing model 20 may generate the chapter list based on the prompt and the chapter group data (S1348).

In an example, the prompt may include a UI condition for generating the chapter list. The content analyzing model 20 may generate the chapter list based on the UI condition.

The electronic apparatus 100 may obtain the chapter list through the content analyzing model 20. The content analyzing model 20 may generate the chapter list. There may be various apparatuses in which the content analyzing model 20 is present.

In an example, the content analyzing model 20 may be included in the electronic apparatus 100. The electronic apparatus 100 may directly store the content analyzing model 20 in an on-device method in the memory 110. The electronic apparatus 100 may generate, based on the first user input for performing the chapter function being received, the chapter list by using the content analyzing model 20 stored in the memory 110.

In an example, the content analyzing model 20 may be included in the external device connected with the electronic apparatus 100. In an example, the external device may be the server 200. In an example, the external device may be the content providing device.

FIG. 14 is a diagram illustrating an operation for obtaining script information according to an embodiment.

Referring to FIG. 14, the content analyzing model 20 may obtain at least one from among the image data, the audio data, and the subtitle data corresponding to the content (S1405).

The electronic apparatus 100 may determine whether the subtitle data is obtained (S1410).

If the subtitle data is not obtained (S1410-N), the content analyzing model 20 may obtain the script information based on the audio data (S1415).

If the subtitle data is obtained (S1410-Y), the content analyzing model 20 may obtain the script information based on the subtitle data (S1420).

A first resource may be required in performing operation S1415. A second resource may be required in performing operation S1420. A size of the first resource may be greater than that of the second resource.

The content analyzing model 20 may generate the content group data by grouping the image data, the audio data, and the script information based on time (S1425). When the content group data is generated, the content analyzing model 20 may perform operations S1342 to S1348 in FIG. 13.

FIG. 15 is a diagram illustrating content group data according to an embodiment.

Table 1500 in FIG. 15 may indicate content group data. The content group data may include matching data that matches at least one from among the image data, the audio data, and the script information based on time.

In an example, the content group data may include a first content group (#01). The first content group (#01) may include first image data (i1), first audio data (a1), and first script information (s1) that matches with a first time-point (t1).

In an example, at least one from among the image data, the audio data, and the script information included in the content group data may be overlapped.

In an example, data corresponding to a portion of unit time may not be present. Audio data or script information at a specific time-point may not be present.

In an example, the content group data may include groups of a number that corresponds to the unit time.

FIG. 16 is a diagram illustrating a profile according to an embodiment.

Table 1600 in FIG. 16 may indicate profiles. The profiles may include the weight value information by context. The context may be classified according to theme.

In an example, a plurality of contexts may be present in one theme.

In an example, the weight value information by context may vary.

The weight value information may include weight values. The weight values may indicate a preference of the user. This may mean that the user preference is high the higher the weight value is.

FIG. 17 is a diagram illustrating a prompt according to an embodiment.

Embodiment 1700 in FIG. 17 may indicate the prompt. The prompt may indicate condition data used in generating the chapter list in the content analyzing model 20.

The prompt may include at least one condition necessary in generating the chapter list. The condition may be described as a standard, a premise, a rule, and the like.

In an example, the prompt may include instructions instructing to classify the content by theme by analyzing the content group data and the metadata.

In an example, the prompt may include information that the content group data includes the image, the audio, and the script by time.

In an example, the prompt may include an instruction instructing for the theme of the content to be selected (or determined) using the profile information (priority information).

In an example, the prompt may include a condition that the chapter list must include the content section by chapter.

In an example, the prompt may include a condition that a portion of the content section may be overlapped.

In an example, a condition that a title by chapter, content time included in the chapter, and a thumbnail image representing the chapter must be included in the chapter list may be included.

In an example, a UI condition 1710 of the chapter list may be included.

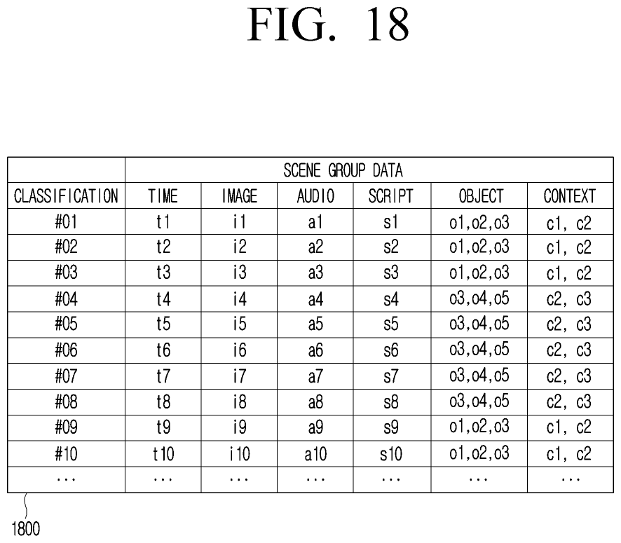

FIG. 18 is a diagram illustrating scene group data according to an embodiment.

Table 1800 in FIG. 18 may indicate scene group data. The scene group data may include matching data that matches at least one from among the image data, the audio data, the script information, the scene object, and the scene context based on time.

In an example, the scene group data may include a first scene group (#01). The first scene group (#01) may include a first image data (i1), a first audio data (a1), and a first script information (s1) that matches with a first time-point (t1), scene objects o1, o2, and o3 identified from the first image data (i1), and scene contexts c1 and c2 identified from the first image data (i1).

In an example, at least one from among the image data, the audio data, the script information, the scene object, and the scene context included in the scene group data maybe overlapped.

In an example, data corresponding to a portion of the unit time may not be present. The audio data, the script information, the scene object, or the scene context may not be present at a specific time-point.

In an example, the scene group data may include groups of a number corresponding to the unit time.

The scene group data may be described as frame group data.

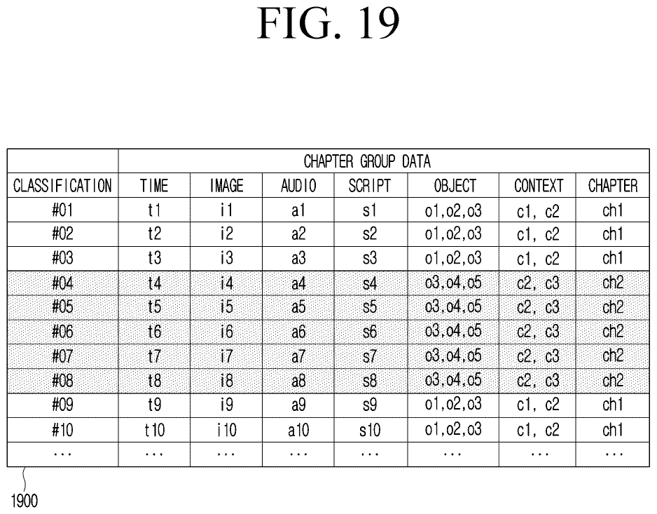

FIG. 19 is a diagram illustrating chapter group data according to an embodiment.

Table 1900 in FIG. 19 may indicate chapter group data. The chapter group data may include matching data that matches at least one from among the image data, the audio data, the script information, the scene object, the scene context, and the target chapter based on time.

In an example, the chapter group data may include a first chapter group (#01). The first chapter group (#01) may include first image data (i1), first audio data (a1), and first script information (s1) that matches with a first time-point (t1), scene objects o1, o2, and o3 identified from the first image data (i1), scene contexts c1 and c2 identified from the first image data (i1), and a first target chapter (ch1) corresponding to the first image data (i1).

In an example, the electronic apparatus 100 may identify the target frame corresponding to the target chapter based on the scene context. The electronic apparatus 100 may identify a first target frame group (#01, #02, #03, #09, #10, . . . ) corresponding to the first target chapter (ch1). The electronic apparatus 100 may identify a second target frame group (#04, #05, #06, #07, #08, . . . ) corresponding to a second target chapter (ch2).

FIG. 20 Is a Diagram Illustrating a Chapter List According to an embodiment.

Embodiment 2000 in FIG. 20 may indicate the chapter list. The chapter list may include content information. The content information may include at least one from among information indicating a name, a production company, a production date, playback time, and whether it is a real-time content. The chapter list may be information in which a plurality of chapters constituting content are arranged and displayed in a predetermined format. A chapter list may be described as a chapter catalog, a chapter set, a chapter group data, a chapter index, a chapter table, a section list, a segment list, or an index list.

The chapter list may include at least one chapter UI. The chapter list may include a first chapter UI 2010 and a second chapter UI 2020.

The chapter UI may include at least one from among names of the target chapters, a target frame corresponding to a target chapter, UIs 2011 and 2021 for playing back the target frame, and description information describing the target chapter.

FIG. 21 is a diagram illustrating an operation for generating a chapter list in a server according to an embodiment.

FIG. 21 may indicate an embodiment in which the content analyzing model 20 is included in the server 200.

Operations S2110, S2120, S2130, and S2150 in FIG. 21 may correspond to operations S1110, S1120, S1130, and S1150 in FIG. 11. Operations S2155 and S2165 in FIG. 21 may correspond to S1255 and S1265 in FIG. 12. Operations S2141, S2142, S2145, S2146, and S2148 in FIG. 21 may correspond to operations S1341, S1342, S1345, S1346, and S1348 in FIG. 13. Redundant descriptions thereof will be omitted.

The electronic apparatus 100 may obtain the content source data (S2110). The electronic apparatus 100 may obtain the profile (S2120). The electronic apparatus 100 may obtain the prompt (S2130). The electronic apparatus 100 may transmit at least one from among the content source data, the profile, or the prompt to the server 200 (S2135).

The server 200 may receive at least one from among the content source data, the profile, or the prompt from the electronic apparatus 100. The server 200 may generate the content group data (S2141). The server 200 may analyze the frame (S2142). The server 200 may obtain the scene object and the scene context by analyzing the frame. The server 200 may determine the target chapter (S2145). The server 200 may determine the target frame corresponding to the target chapter (S2146). The server 200 may generate the chapter list based on the target chapter and the target frame (S2148). The server 200 may transmit the chapter list to the electronic apparatus 100 (S2149).

The electronic apparatus 100 may receive the chapter list from the server 200. The electronic apparatus 100 may provide the chapter list (S2150). In an example, the electronic apparatus 100 may display the chapter list on the display 140. The electronic apparatus 100 may identify whether the second user input for the chapter list is received (S2155). When the second user input is received (S2155-Y), the electronic apparatus 100 may update the profile based on the second user input (S2165).

FIG. 22 is a diagram illustrating an operation for performing a chapter function using a plurality of external devices according to an embodiment.

FIG. 22 may indicate an embodiment in which the content analyzing model 20 is included in a second server 220.

Operation S2230 and S2250 in FIG. 22 may correspond to operations S1130 and S1150 in FIG. 11. Operations S2255 and S2265 in FIG. 22 may correspond to S1255 and S1265 in FIG. 12. Operations S2241, S2242, S2245, S2246, and S2248 in FIG. 22 may correspond to operations S1341, S1342, S1345, S1346, and S1348 in FIG. 13. Redundant descriptions thereof will be omitted.

Referring to FIG. 22, the electronic apparatus 100 may be connected to a first server 210, the second server 220, and a content providing device 300.

The electronic apparatus 100 may request for the content source to the content providing device 300 (S2211).

The content providing device 300 may receive a content source request from the electronic apparatus 100. The content providing device 300 may transmit the content source data to the electronic apparatus 100 (S2212). The content providing device 300 may transmit the content source data corresponding to the content source request to the electronic apparatus 100.

The electronic apparatus 100 may receive the content source data from the content providing device 300. The electronic apparatus 100 may request for the profile to the first server 210 (S2221).

The first server 210 may receive the request for the profile from the electronic apparatus 100. The first server 210 may transmit the profile to the electronic apparatus 100 (S2222). The first server 210 may transmit, to the electronic apparatus 100, the profile corresponding to the user (or a user account) of the electronic apparatus 100.

The electronic apparatus 100 may receive the profile from the first server 210. The electronic apparatus 100 may obtain the prompt (S2230). The electronic apparatus 100 may transmit at least one from among the content source data, the profile, and the prompt to the second server 220.

The second server 220 may receive at least one from among the content source data, the profile, and the prompt from the electronic apparatus 100.

The second server 220 may receive at least one from among the content source data, the profile, or the prompt from the electronic apparatus 100. The second server 220 may generate the content group data (S2241). The second server 220 may analyze the frame (S2242). The second server 220 may obtain the scene object and the scene context by analyzing the frame. The second server 220 may determine the target chapter (S2245). The second server 220 may determine the target frame corresponding to the target chapter (S2246). The second server 220 may generate the chapter list based on the target chapter and the target frame (S2248). The second server 220 may transmit the chapter list to the electronic apparatus 100 (S2249).

The electronic apparatus 100 may receive the chapter list from the second server 220. The electronic apparatus 100 may provide the chapter list (S2250). In an example, the electronic apparatus 100 may display the chapter list on the display 140. The electronic apparatus 100 may identify whether the second user input for the chapter list is received (S2255). When the second user input is received (S2255-Y), the electronic apparatus 100 may transmit the chapter use history associated with the second user input to the first server 210 (S2256).

The first server 210 may receive the chapter use history from the electronic apparatus 100. The first server 210 may update the profile based on the chapter use history (S2265).

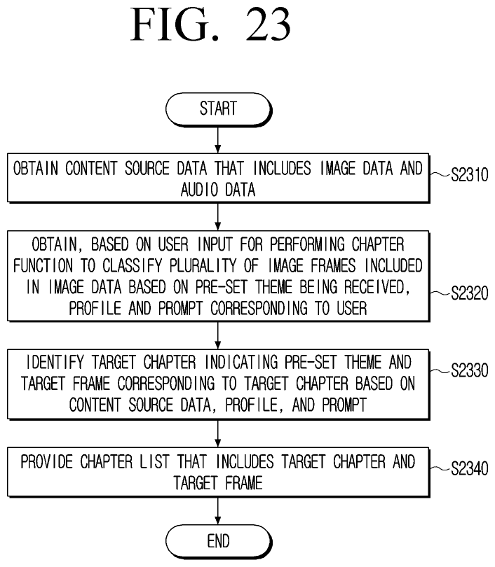

FIG. 23 is a diagram illustrating a controlling method of the electronic apparatus 100 according to an embodiment.

Referring to FIG. 23, the controlling method of the electronic apparatus 100 may include obtaining the content source data that includes the image data and the audio data (S2310), obtaining, based on the user input for performing the chapter function to classify the plurality of image frames included in the image data based on the pre-set theme being received, the profile and the prompt corresponding to the user (S2320), identifying the target chapter indicating the pre-set theme and the target frame corresponding to the target chapter based on the content source data, the profile, and the prompt (S2330), and providing the chapter list that includes the target chapter and the target frame (S2340).

The profile may include weight value information that indicates the priority with respect to the context, and the prompt may include the condition for generating the chapter list.

The identifying the target chapter (S2330) may include identifying the scene object included in the plurality of image frames, identifying the scene context included in the plurality of image frames based on the scene object, and identifying the target chapter based on the profile, the prompt, the scene object, and the scene context.

The controlling method may include obtaining the script information indicating the gist of the content based on the content source data and identifying at least one from among the scene object or the scene context based on the script information.

The identifying the target frame (S2330) may include identifying the target frame corresponding to the target chapter from among the plurality of image frames based on the scene object and the scene context.

The identifying the target frame (S2330) may include obtaining the representative object and the representative context corresponding to the target chapter, obtaining the first similarity of the representative object and the scene object, obtaining the second similarity of the representative context and the scene context, and identifying the target frame corresponding to the target chapter from among the plurality of image frames based on at least one from among the first similarity or the second similarity.

The identifying the target frame (S2330) may include identifying, based on the first similarity being greater than or equal to the first threshold value, the image frame that includes the scene object corresponding to the first similarity as the target frame, and identifying, based on the second similarity being greater than or equal to the second threshold value, the image frame that includes the scene context corresponding to the second similarity as the target frame.

The controlling method may include updating the profile based on at least one from among the content viewing history, the content search history, or the chapter use history.

The user input may be the first user input, and the updating the profile in the controlling method may include obtaining, based on the second user input for selecting the chapter list being received, the chapter use history based on the second user input, and updating the profile based on the chapter use history.

The controlling method may include obtaining the chapter list by inputting the content source data, the profile, and the prompt in the content analyzing model, and the content analyzing model may include the large language model (LLM).

Methods according to the various embodiments of the disclosure described above may be implemented in an application form installable in electronic apparatuses of the related art.

The methods according to the various embodiments of the disclosure described above may be implemented with only a software upgrade, or a hardware upgrade for the electronic apparatuses of the related art.

The various embodiments of the disclosure described above may be performed through an embedded server provided in an electronic apparatus, or at least one external server from among the electronic apparatus and a display device.

According to an embodiment of the disclosure, the various embodiments described above may be implemented with software including instructions stored in a machine-readable storage media (e.g., a computer). The machine may call a stored instruction from a storage medium, and as an apparatus operable according to the called instruction, may include the electronic apparatus according to the above-mentioned embodiments. Based on a command being executed by the processor, the processor may directly or using other elements under the control of the processor perform a function relevant to the command. The command may include a code generated by a compiler or executed by an interpreter. The machine-readable storage media may be provided in a form of a non-transitory storage medium. Herein, ‘non-transitory’ merely means that the storage medium is tangible and does not include a signal, and the term does not differentiate data being semi-permanently stored or being temporarily stored in the storage medium.

According to an embodiment of the disclosure, a method according to the various embodiments described above may be provided included a computer program product. The computer program product may be exchanged between a seller and a purchaser as a commodity. The computer program product may be distributed in a form of a machine-readable storage medium (e.g., a compact disc read only memory (CD-ROM)), or distributed online through an application store. In the case of online distribution, at least a portion of the computer program product may be stored at least temporarily in the storage medium such as a server of a manufacturer, a server of an application store, or a memory of a relay server, or temporarily generated.

Each of the elements (e.g., a module or a program) according to various embodiments described above may be configured as a single entity or a plurality of entities, and a portion of sub-elements of the above-mentioned relevant sub-elements may be omitted, or other sub-elements may be further included in the various embodiments. Alternatively or additionally, a portion of the elements (e.g., modules or programs) may be integrated into one entity to perform the same or similar functions performed by each of the relevant elements prior to integration. Operations performed by a module, a program, or another element, in accordance with various embodiments, may be executed sequentially, in a parallel, repetitively, or in a heuristic manner, or at least a portion of the operations may be executed in a different order, omitted, or a different operation may be added.

While the disclosure has been illustrated and described with reference to example embodiments thereof, it will be understood that the embodiments are intended to be illustrative, not limiting. It will be understood by those skilled in the art that various changes in form and details may be made therein without departing from the true spirit and full scope of the disclosure, including the appended claims and their equivalents.

What is claimed is:

1. An electronic apparatus, comprising:
a memory storing instructions; and
at least one processor comprising processing circuitry,
wherein the instructions, when executed individually or collectively by the at least one processor, cause the electronic apparatus to:
obtain content data that comprises image data and audio data,
obtain, based on a user input for performing a chapter function that is associated with classifying a plurality of image frames comprised in the image data for a pre-set theme being received, a profile and a prompt corresponding to a user, and
provide a chapter list that comprises a target chapter associated with the pre-set theme and a target frame corresponding the target chapter based on the content data, the profile, and the prompt.

2. The electronic apparatus of claim 1, wherein
the profile comprises weight value information corresponding to priority with respect to context, and
the prompt comprises a condition corresponding to generating the chapter list.

3. The electronic apparatus of claim 2, wherein the instructions, when executed individually or collectively by the at least one processor, cause the electronic apparatus to:
obtain a scene context comprised in the plurality of image frames based on a scene object comprised in the plurality of image frames, and
identify the target chapter based on the profile, the prompt, the scene object, and the scene context.

4. The electronic apparatus of claim 3, wherein the instructions, when executed individually or collectively by the at least one processor, cause the electronic apparatus to:
obtain script information corresponding to a content gist based on the content data, and
obtain at least one from among the scene object or the scene context based on the script information.

5. The electronic apparatus of claim 3, wherein the instructions, when executed individually or collectively by the at least one processor, cause the electronic apparatus to:
identify the target frame corresponding to the target chapter from among the plurality of image frames based on the scene object and the scene context.

6. The electronic apparatus of claim 5, wherein the instructions, when executed individually or collectively by the at least one processor, cause the electronic apparatus to:
obtain a representative object and a representative context corresponding to a target chapter,
obtain a first similarity of the representative object and the scene object,
obtain a second similarity of the representative context and the scene context, and identify the target frame corresponding to the target chapter from among the plurality of image frames based on at least one from among the first similarity or the second similarity.

7. The electronic apparatus of claim 6, wherein the instructions, when executed individually or collectively by the at least one processor, cause the electronic apparatus to:
identify, based on the first similarity being greater than or equal to a first threshold value, an image frame comprising a scene object corresponding to the first similarity as the target frame, and
identify, based on the second similarity being greater than or equal to a second threshold value, an image frame comprising a scene context corresponding to the second similarity as the target frame.

8. The electronic apparatus of claim 1, wherein the instructions, when executed individually or collectively by the at least one processor, cause the electronic apparatus to:
update the profile based on at least one from among a content viewing history, a content search history, or a chapter use history.

9. The electronic apparatus of claim 8, wherein
the user input is a first user input, and
the instructions, when executed individually or collectively by the at least one processor, cause the electronic apparatus to:
update, based on a second user input corresponding to selecting the chapter list being received, the profile based on chapter use history obtained based on the second user input.

10. The electronic apparatus of claim 1, wherein the instructions, when executed individually or collectively by the at least one processor, cause the electronic apparatus to:
obtain the chapter list through an artificial intelligence model corresponding to a content analysis based on the content data, the profile, and the prompt.

11. A controlling method of an electronic apparatus, the controlling method comprising:
obtaining content data that comprises image data and audio data;
obtaining, based on a user input for performing a chapter function that is associated with classifying a plurality of image frames comprised in the image data for a pre-set theme being received, a profile and a prompt corresponding to a user; and
providing a chapter list that comprises a target chapter associated with the pre-set theme and a target frame corresponding the target chapter based on the content data, the profile, and the prompt.

12. The controlling method of claim 11, wherein
the profile comprises weight value information corresponding to priority with respect to context, and
the prompt comprises a condition corresponding to generating the chapter list.

13. The controlling method of claim 12, further comprising:
obtaining a scene context comprised in the plurality of image frames based on a scene object comprised in the plurality of image frames; and
identifying the target chapter based on the profile, the prompt, the scene object, and the scene context.

14. The controlling method of claim 13, further comprising:
obtaining script information corresponding to a content gist based on the content data; and
obtaining at least one from among the scene object or the scene context based on the script information.

15. The controlling method of claim 13, further comprising:
identifying the target frame corresponding to the target chapter from among the plurality of image frames based on the scene object and the scene context.
